(19) United States
(12) Patent Application Publication
(10) Pub. No.: US 2010/0242651 A1
(43) Pub. Date: Sep. 30, 2010

(54) ROLLING-ELEMENT SCREW DEVICE

(75) Inventors: Takeki Shirai, Tokyo (JP); Katsuya Iida, Tokyo (JP); Soshi Miyahara, Tokyo (JP); Tsutomu Togashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 12/731,813

(22) Filed: Mar. 25, 2010

(30) Foreign Application Priority Data
Mar. 31, 2009 (JP) 2009-085249

(51) Int. Cl. F16H 25/22

(52) U.S. Cl. 74/424.83; 74/424.87

(57) ABSTRACT

Provided is a rolling-element screw device in which a recess can be easily formed in an outer diameter portion of a nut main body for receiving a circulation member. At both ends of a straight passage 5 of the nut main body 2, a pair of circulation members 8 is provided respectively, in each of which a direction change passage 6 is formed for connecting the straight passage 5 to a loaded rolling-element rolling passage 3. The circulation members 8 in a pair are fit in a pair of recesses 15, respectively, formed in the outer diameter portion of the nut main body 2. The direction change passage 6 of each circulation member 8 has a curve passage 22 which is connected to the loaded rolling-element rolling passage 3. The curve passage 22 is formed in such a way that, when seen in the axial direction of the nut main body 2, the track of the center of each rolling element 7 moving in the curve passage takes the shape of an arc.

### BACKGROUND OF THE INVENTION

1. Field of the Invention

The present invention relates to a rolling-element screw device having a plurality of rolling elements rollably arranged between a screw shaft and a nut main body.

2. Description of the Related Art

A rolling-element screw device is a mechanical element for converting rotary motion into linear motion. In order to reduce a friction that occurs when a screw shaft is rotated relative to a nut, there is a plurality of rolling elements, such as balls or rollers, arranged rollable between the screw shaft and the nut main body. The rolling elements rolling between the screw shaft and the nut can be circulated by circulation members mounted in the nut. There are various systems for the circulation member circulating the rolling elements, such as a return pipe system and an end cap system.

The return pipe system is a most common circulation system for circulating the rolling elements by a return pipe mounted on an outer diameter portion of the nut main body. Both ends of the return pipe are bent into a gate shape and inserted into the outer diameter portion of the nut. The rolling elements rolling in the loaded rolling-element rolling passage between the screw shaft and the nut roll to one end of the loaded rolling-element rolling passage, are scooped up into the return pipe, roll through the return pipe as unloaded return passage and then, are returned to the other end of the loaded rolling-element rolling passage.

The end cap system is such that a straight passage extending in parallel with the axial line of the nut main body and a pair of end caps mounted at the respective end surfaces in the axial direction of the nut main body are used to circulate the rolling elements. In each end cap, a direction change passage is formed connecting the straight passage of the nut main body and the loaded rolling-element rolling passage.

Japanese Patent Laid-Open No. 46-31564 discloses a ball screw adopting the end cap type circulation system, in which balls are circulated by a ball return passage extending in the nut main body in the axial direction and blocks and pins provided respective ends of the ball return passage. In each block, a direction change passage is formed for connecting a loaded ball rolling groove of a nut and the ball return passage. Once each ball rolls up to one end of the loaded ball rolling passage, it is scooped up into the block by a tip end of the pin and guided by the direction change passage of the block into the return passage extending straightly.

However, in the ball screw disclosed in the above-mentioned publication, balls moving in the loaded ball rolling passage are scooped up in the tangential direction of a circle when seen in the axial direction of the nut main body. Therefore, the direction change passage of the block is arranged in the tangential direction of the loaded ball rolling passage and a hole for receiving the block is also formed in the tangential direction of the loaded ball rolling passage. Then, when seen in the axial direction of the nut main body, the center line of the direction change passage of the front-side block and the center line of the direction change passage of the back-side block are crossed each other in a V shape (see FIG. 2 of JP 46-31564 B), and the holes for receiving the respective blocks are also formed in the outer diameter portion of the nut main body in the crossing two directions. When the holes are formed in the outer diameter potion of the nut main body in the different two directions, even with use of a composite lathe, there is a need to re-catch the nut main body or rotate the nut main body, which brings about difficulties. If the holes can be formed in two directions, the position of each of the holes is sometimes shifted relative to the loaded ball rolling groove of the nut main body.

Then, the present invention provides a rolling-element screw device in which a recess can be easily formed in an outer diameter portion of a nut main body for inserting a circulation member.

### BRIEF SUMMARY OF THE INVENTION

An exemplary embodiment of the present invention will be described below.

In order to solve above-mentioned problems, one aspect of the present invention is a rolling-element screw device comprising: a screw shaft having a spiral rolling-element rolling groove formed on an outer peripheral surface thereof; a nut main body having a spiral loaded rolling-element rolling groove formed on an inner peripheral surface thereof, facing the rolling-element rolling groove of the screw shaft; a plurality of rolling elements arranged in a rolling-element circulation passage including a loaded rolling-element rolling passage between the loaded rolling-element rolling groove of the nut main body and the rolling-element rolling groove of the screw shaft; a straight passage provided in the nut main body and having a hole extending in parallel with an axial line of the nut main body; and a pair of circulation members provided at respective ends of the straight passage of the nut main body and each having formed therein a direction change passage for connecting the loaded rolling-element rolling passage and the straight passage, the circulation members being formed in an outer diameter portion of the nut main body and fit in a pair of recesses, respectively, connected to the straight passage, the direction change passage of each of the circulation members having a curve passage connected to the loaded rolling-element rolling passage, and the curve passage being formed in such a manner that a track of a center of each of the rolling elements moving in the curve passage takes an arc shape when seen in an axial direction of the nut main body.

According to this aspect of the present invention, in each of the paired circulation members provided at the respective ends of the straight passage of the nut main body, the curve passage is formed in such a manner that the center line takes the shape of a circular arc when seen in the axial direction of the nut main body. When seen in the axial direction of the nut main body, the length from the position where each rolling element is scooped up to the position where the rolling element is guided to the straight passage in the circulation member can be shorter than such a length of a conventional block in which a direction change passage is formed for scooping up rolling elements in the tangential direction of a loaded rolling-element rolling passage. Hence, the insertion direction into the recess of one of the paired circulation members provided at the respective ends of the straight passage of the nut main body can be the same as that of the other circulation member, and also, working of the recesses in the nut main body can be facilitated.

### BRIEF DESCRIPTION OF THE SEVERAL VIEWS OF THE DRAWING

The above and other objects and features of the invention will appear more fully hereinafter from a consideration of the following description taken in connection with the accompanying drawing wherein one example is illustrated by way of example, in which;

FIG. 1 is a perspective view of a ball screw according to a first exemplary embodiment of the present invention.

FIG. 2 is a cross-sectional view of the ball screw.

FIG. 3 is a cross-sectional view of a loaded ball rolling groove of a nut and a ball rolling groove of a screw shaft.

FIG. 4 is a plan view of the ball screw.

FIG. 5 is a plan view of a nut main body.

FIG. 6 is a cross-sectional view of the nut main body on which a circulation member is mounted, the view taken along a line perpendicular to the axis line of the nut main body.

FIG. 7 is a view illustrating a ball circulation passage.

FIG. 8 is a perspective view of an unloaded return passage developed on the screw shaft.

FIG. 9 is a view illustrating a center line of the ball circulation passage seen from the side surface side of the nut.

FIG. 10 is a view illustrating a center line of the unloaded return passage seen in the axial direction of the nut.

FIG. 11 is a perspective view of the circulation member.

FIG. 12 is a perspective view of the circulation member seen from the bottom.

### DETAILED DESCRIPTION OF THE INVENTION

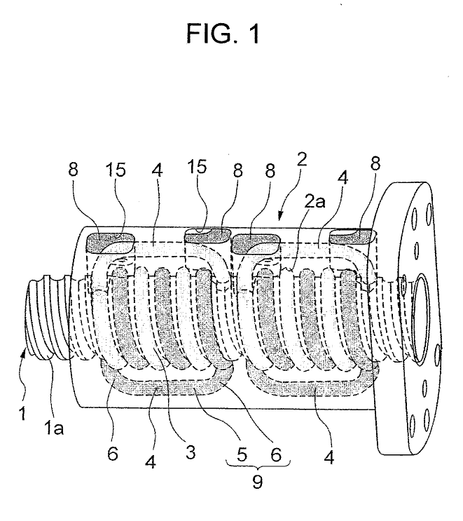

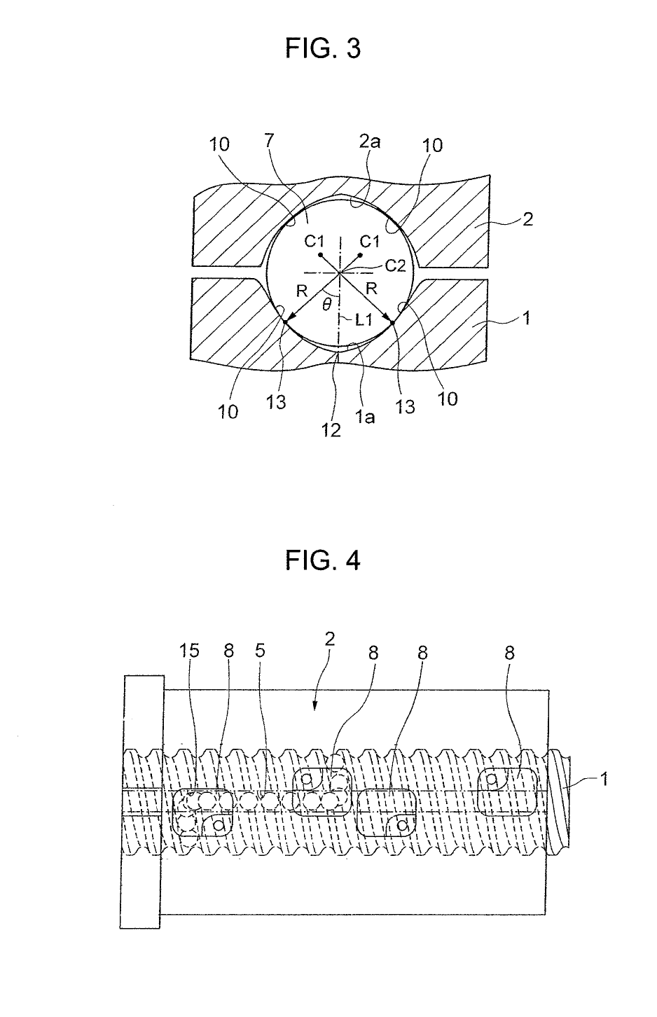

FIG. 1 is a perspective view of a ball screw as a rolling-element screw device according to a first exemplary embodiment of the present invention. The ball screw has a screw shaft 1 having a spiral ball rolling groove 1a as a rolling-element rolling groove formed on an outer peripheral surface thereof and a nut main body 2 having a spiral loaded ball rolling groove 2a as a loaded rolling-element rolling groove formed on an inner peripheral surface thereof, facing the ball rolling groove 1a. In a loaded ball rolling passage 3 between the loaded ball rolling groove 2a of the nut main body 2 and the ball rolling groove 1a of the screw shaft 1, a plurality of balls 7 (see FIG. 3) as rolling elements are arranged rollably.

In the ball screw, ball circulation passages are provided for circulating the balls 7. In this embodiment, two passages are provided shifted from each other in the axial direction of the nut main body 2, and two passages are provided shifted from each other in the circumferential direction of the nut main body 2. In total, four ball circulation passages 4 are provided here. The number of the ball circulation passages 4 is determined appropriately in accordance with the number of the loaded ball rolling passages and a load on the ball screw.

The two ball circulation passages 4 are provided as shifted from each other in the axial direction of the nut main body 2 in order to preload the ball screw and to reduce the number of turns of each ball circulation passage 4. When the number of turns of the ball circulation passage 4 is increased, if the accuracy of mounting of the ball screw to another device and the accuracy of manufacturing of the ball rolling grooves 1a and the loaded ball rolling grooves 2a are reduced, the balls 7 positioned just before and after rolling on the loaded ball rolling passage 3 sometimes roll at different moving speeds and are pushed against each other. This phenomenon is avoided by reducing the number of turns of each passage.

In addition, as the two ball circulation passages 4 are provided as shifted from each other in the circumferential direction of the nut main body 2, the balls 7 can circulate in the two loaded ball rolling passages 3, respectively. As the two loaded ball rolling passages 3 are provided, the nut main body 2 can be moved at a high speed and the rigidity can be enhanced.

Each of the ball circulation passages 4 includes a spiral loaded ball rolling passage 3 formed between the ball rolling groove 1a of the screw shaft 1 and the loaded ball rolling groove 2a of the nut main body 2 and an unloaded return passage 9 connecting an end of the loaded ball rolling passage 3 to the other. In the loaded ball rolling passage 3, each ball 7 is sandwiched between the loaded ball rolling groove 2a of the nut main body 2 and the ball rolling groove 1a of the screw shaft 1 and bears a compressive load. In the unloaded return passage 9, the ball moves as pushed by its following ball 7 under no compressive load.

The unloaded return passage 9 includes a straight passage extending in parallel with the axial line of the nut main body 2 and a pair of direction change passages 6 provided at respective ends of the straight passage 5. The straight passage 5 is a hole formed in the nut main body 2 from one end surface of the nut main body 2 to be in parallel with the axial line of the nut main body 2. Each direction change passage 6 is formed inside a circulation member 8 as a circulation member fit in the outer diameter portion of the nut main body 2. A pair of circulation members 8 is provided at respective ends of each straight passage 5. In the conventional end cap type ball screw, a direction change passage 6 is formed in an end cap (end surface component) fit in the end surface of the nut in the axial direction. On the other hand, in the ball screw of the present exemplary embodiment, the direction change passage 6 is formed in the circulation member 8 fit on the outer diameter portion of the nut main body 2. The direction change passage 6 formed in the circulation member 8 connects an end of the straight passage 5 to an end of the spiral loaded ball rolling passage 3.

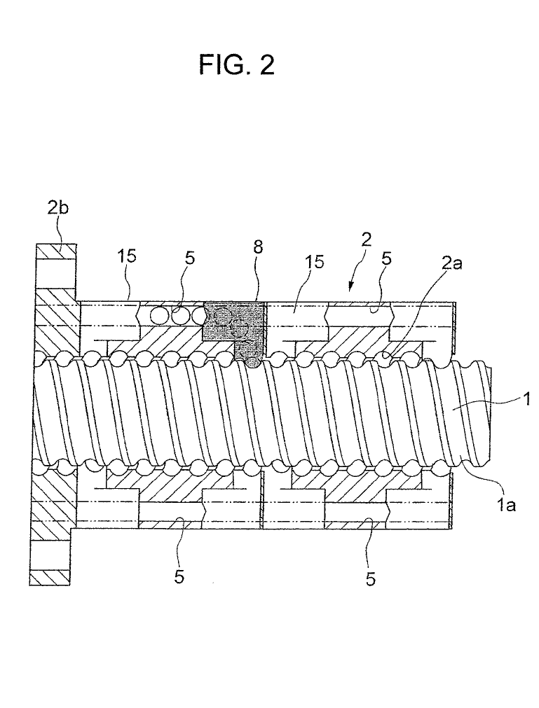

FIG. 2 is a cross-sectional view of the nut main body 2 and the screw shaft 1. In the outer peripheral surface of the screw shaft 1, two ball rolling grooves 1a are formed with a predetermined lead by cutting or rolling. The number of ball rolling grooves 1a may be one, two, three or any other number, which may be set appropriately. As illustrated in FIG. 3, each ball rolling groove 1a has a cross section of Gothic arch groove shape having two circular arcs 10 of radius that is slightly larger than the radius of the ball 7. The centers C1 of the two arcs of the Gothic arch groove are positioned away from the center C2 of the ball 7. The ball 7 is in contact with the ball rolling groove 1a of Gothic arch groove shape at two points. The line L1 connecting the center C2 of the ball 7 and the bottom 12 of the Gothic arch groove forms a contact angle θ with respect to the line connecting the center C2 of the ball 7 and the contact point 13 of the ball 7, and the contact angle θ is set to be 40 to 50 degrees, for example. The ball rolling groove 1a is first subjected to heat treatment and then grinding.

As illustrated in FIG. 2, in the inner peripheral surface of the nut main body 2, two spiral loaded ball rolling grooves 2a are formed with a predetermined lead by cutting. At an end in the axial direction of the nut main body 2, a flange 2b is formed for mounting the nut main body 2 on another device. As illustrated in FIG. 3, the loaded ball rolling groove 2a has a cross section of Gothic arch groove shape including two circular arcs 10 of radius slightly larger than the radius of the ball 7. The Gothic arch groove shape is the same as that of the ball rolling groove 1a of the screw shaft 1. The loaded ball rolling groove 2a is first subjected to heat treatment and then to grinding.

In order to preload the ball screw, the loaded ball rolling grooves 2a of two ball circulation passages 4 arranged in the nut main body 2 as shifted from each other in the axial direction have only to be out of phase. In other words, while the lead of the left-side loaded ball rolling groove 2a is matched with the lead of the right-side loaded ball rolling groove 2a, the left-side loaded ball rolling groove 2a is shifted in the axial direction of the nut main body 2 with respect to the right-side ball rolling groove 2a. As they are shifted from each other, the distance between the left-side loaded ball rolling groove 2a and the right-side loaded ball rolling groove 2a is expressed by L (lead)×n (natural number)±δ (shift length).

According to this exemplary embodiment, as the circulation members 8 in a pair of the same circulation system fit in the outer diameter portion of the nut main body 2 are used, it becomes possible to provide in the single nut main body 2 two or more ball circulation passages 4 as shifted from each other in the axial direction. For this reason, preloading can be facilitated. The shapes of the paired circulation members 8 are the same. Here, the double nut system may be adopted such that two nut main bodies are bonded to each other in the axial direction and a spacer is provided between the two nut main bodies thereby to preload the screw device, or the system may be adopted in which the phase of the screw shaft 1 is shifted at some midpoint thereby to preload the screw device.

In this exemplary embodiment, totally, four ball circulation passages 4 are provided in the ball screw. In the nut main body 2, four straight passages 5 are formed corresponding to the respective four ball circulation passages 4. As illustrated in FIG. 2, two straight passages 5 at one side of the nut main body 2 are aligned in the axial direction of the nut main body in such a manner that the center lines of the two straight passages 5 are in agreement. The two straight passages 5 are formed once by forming through holes from one end surface of the nut main body to the other end surface with use of a drill or the like. As the center lines of the two straight passages 5 are in agreement, the working cost of the through holes can be reduced. Two straight passages at the other side can be also formed once by forming through holes from an end surface to the other end surface of the nut main body with use of a drill or the like.

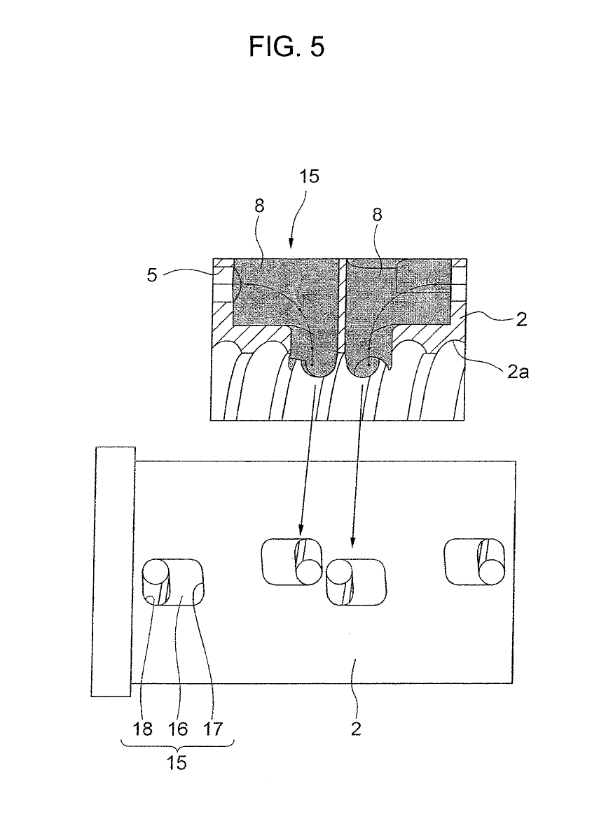

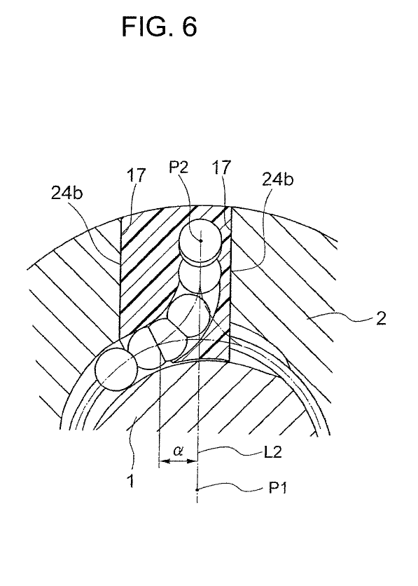

At each end of each of the straight passages 5 of the nut main body 2, a recess 15 is formed worked from the side surface of the nut main body 2. The circulation member 8 is fit in this recess 15 (see FIG. 4). As illustrated in the plan view of the nut main body 2 of FIG. 5, the recess 15 has a bottom surface 16 for fitting the circulation member 8 on, an inner wall 17 surrounding the circulation member 8 and a through hole 18 formed in the bottom surface 16. In the bottom surface 16, a female screw (not shown) is formed for mounting of the circulation member 8. In the through hole 18, an insertion portion 21 (described later) of the circulation member 8 is inserted therethrough. The plan shape of the inner wall 17 is formed into a rectangular shape with corners chamfered. The bottom surface 16 is formed to be plane at one step lower than the outer peripheral surface of the nut main body 2. The bottom surface 16 and the inner wall 17 are orthogonal to each other. As illustrated in FIG. 6, in the cross section perpendicular to the axial line of the nut main body 2, the inner wall 17 of the recess 15 is in parallel with the line L2 connecting the center P2 of the straight passage 5 to the axial line P1 of the nut main body 2. In order that the paired circulation members 8 can be fit in the respective recesses 15 in pair in the direction of the line L2 from the outside of the nut main body 2, the inner walls 17 of the recesses 5 in pair provided at the respective ends of the straight passage 5 are formed in parallel with each other. Each recess 15 is formed by using a milling machine such as an end mill having blades at the tip end and outer circumference of cylindrical shape, inserting the milling machine blades into the side surface of the nut main body 2, giving rotary motion to the milling machine blades and then giving feed motion to the nut main body 2. If a plurality of recess 15 sets is formed in the outer diameter portion of the nut main body 2, they can be formed by milling in the outer diameter portion of the nut main body 2 in the same direction and there is no need to re-catch or rotate the nut main body 2. Therefore, manufacturing of the plural recess 15 sets can be facilitated.

Further, as the amount of works for forming of the recesses 15 can be minimized, the working accuracy can be easily assured, deformation due to the heat treatment is hardly to occur, or the load balance in rotating of the nut can be optimized.

Here, in the plan view of FIG. 5, the loaded ball rolling groove 2a at the back side of the nut main body 2 is illustrated through the through hole 18. The round part inside the through hole 18 is an overlapping part of the upper through hole 18 and the lower through hole 18 of the nut main body 2.

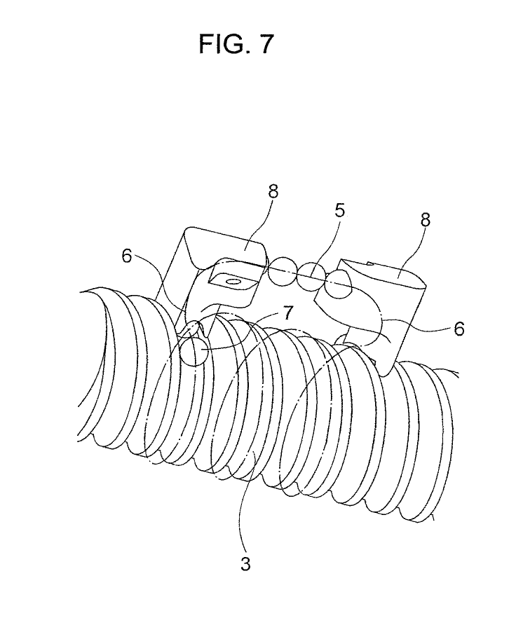

When the screw shaft 1 is rotated relative to the nut main body 2, each ball 7 rolls in the loaded ball rolling passage 3 between the nut main body 2 and the screw shaft 1. As the ball rolling groove 1a of the screw shaft 1 and the loaded ball rolling groove 2a of the nut main body 2 have a predetermined lead, the nut main body 2 moves linearly in the axial direction by rotation of the screw shaft 1. As illustrated in FIG. 7, once each ball 7 rolls up to an end of the loaded ball rolling passage 3, it is guided into the direction change passage 6 of the circulation member 8. After passing through the direction change passage 6 of the circulation member 8, the ball 7 is guided into the straight passage 5 of the nut main body 2. Then, the ball 7 passes through the straight passage 5 of the nut main body 2, is guided into the direction change passage 6 of the other circulation member 8 and is returned to the other end of the loaded ball rolling passage 3.

FIG. 8 is a perspective view of the unloaded return passage 9 developed on the screw shaft 1. As the straight passage 5 is provided in parallel with the axial line of the nut main body 2 and the balls 7 are circulated in parallel with the axial line of the nut main body 2, the inlet and outlet of the unloaded return passage 9 can be provided close to each other when seen in the axial direction of the nut main body 2. Therefore, the number of turns of the loaded ball rolling passage 3 can be close to an integer. Besides, as the balls 7 are scooped at the curve passage 22 (described in detail below) of the circulation member 8 in such a manner as to draw a circular arc, they can circulate smoothly.

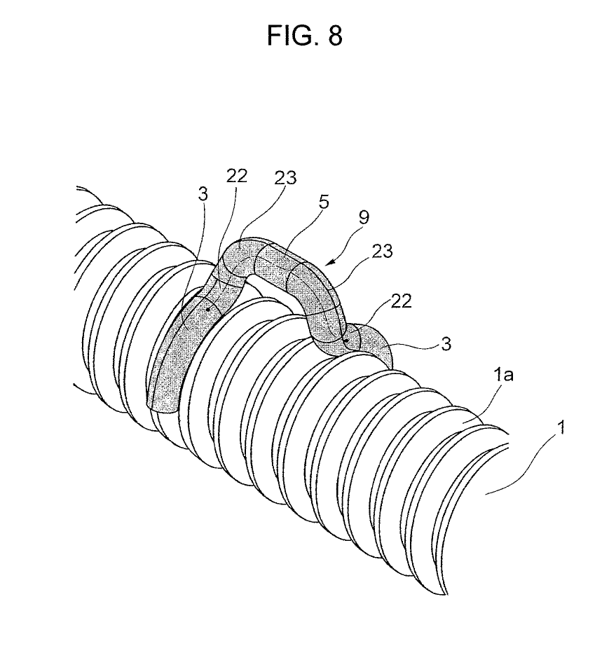

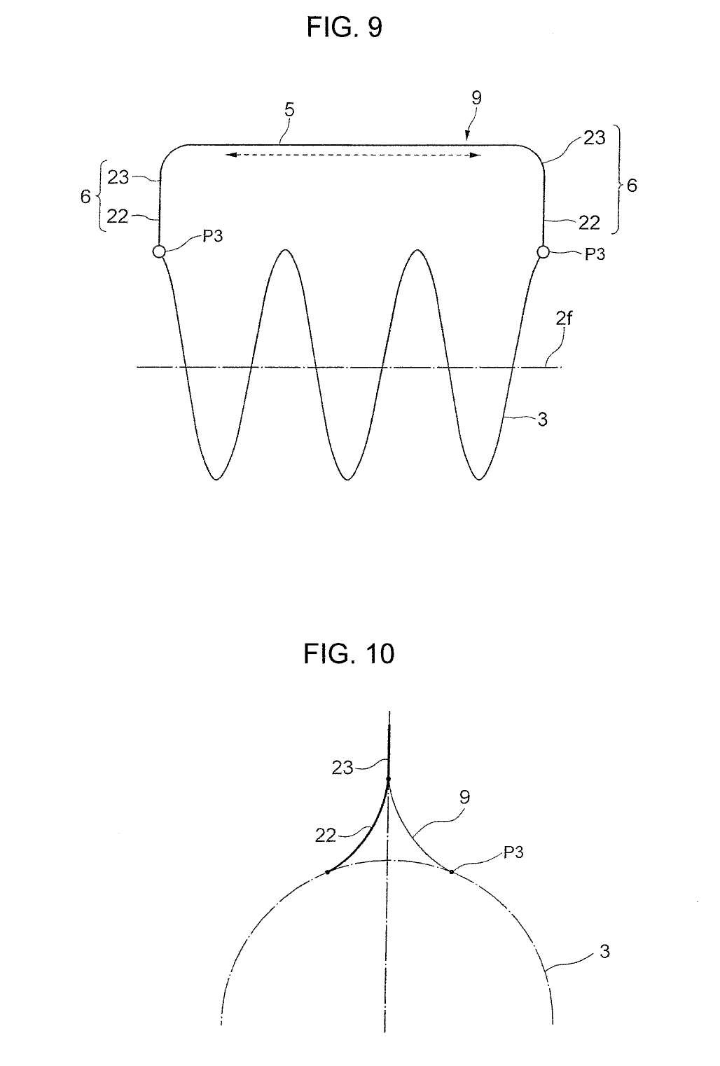

FIG. 9 illustrates the center line of the ball circulation passage (track of the center of each ball 7) seen from the side of the nut main body 2, and FIG. 10 illustrates the center line of the unloaded return passage 9 (track of the center of each ball 7) seen in the axial direction of the nut main body 2. As illustrated in FIG. 9, the unloaded return passage 9 is divided into a straight passage 5 and direction change passages 6 provided at respective ends of the straight passage 5. Each direction change passage 6 is divided into a curve passage 22 and a radial direction passage 23. The center line of the radial direction passage 23 connected to the curve passage 22 first extends in the radial direction of the nut main body 2, then is bent 90 degrees into a circular arc shape toward the center in the axial direction of the nut main body 2 and is connected to the straight passage 5. The center line of the curve passage 22 is perpendicular to the axial line 2f of the nut main body 2 seen from the side of the nut main body 2. The center line of the curve passage 22 may be inclined in accordance with the lead. As illustrated in FIG. 8, the curve passage 22 is connected to the radial direction passage 23 for moving the balls in the radial direction when seen in the axial direction of the nut main body 2.

As illustrated in FIG. 10, the curve passage 22 is formed to be a circular-arc shaped curve convex toward the screw shaft 1, seen in the axial direction of the nut main body 2 and is in contact with the circular loaded ball rolling passage 3. The contact point P3 of the curve passage 22 and the loaded ball rolling passage 3 is an inflection point where the curve line is changed from a convex line to a concave line. At this contact point P3, the tangential direction of the curve passage 22 is continuous to the tangential direction of the loaded ball rolling passage 3. This enables smooth scooping of the balls. Stereoscopically, the center line of the curve passage 22 may be formed to be an arc and the curve passage 22 may be inclined in accordance with the lead of the loaded ball rolling passage 3 so that the tangential direction of the center line becomes continuous at the contact point between the spiral loaded ball rolling passage 3 and the curve passage 22.

In the conventional end cap type ball screw, when seen in the axial direction of the nut main body 2, the direction change passage 6 is arranged in the tangential direction of the arc-shaped loaded ball rolling passage 3. On the other hand, in the ball screw according to the present exemplary embodiment, each ball 7 is scooped up along the arc-shaped track like a linear guide. Hence, as compared with the conventional ball screw in which balls are scooped in the tangential direction, the distance a from the point when the circulation member 8 scoops each ball from the loaded ball rolling passage 3 to the point where it guides the ball to the straight passage 5 can be shortened (see FIG. 6).

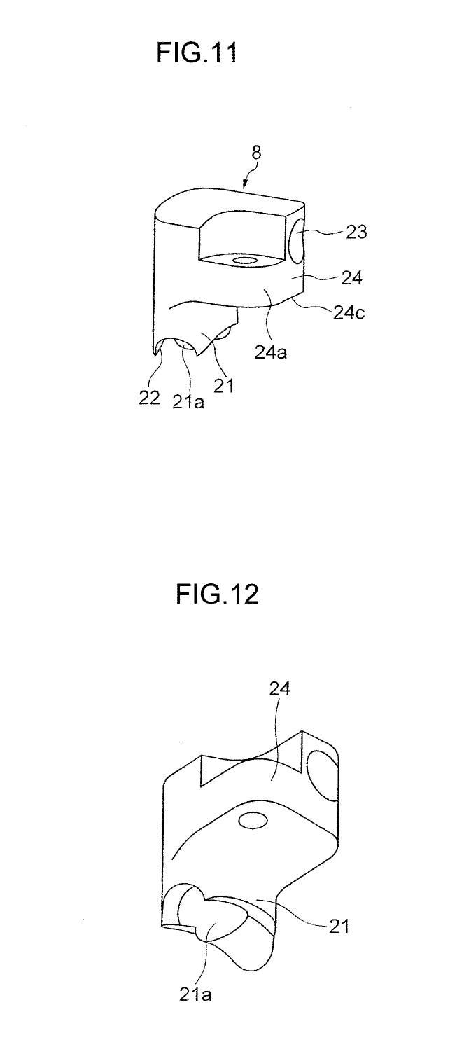

FIGS. 11 and 12 are perspective view of the circulation member 8. The circulation member 8 has a main body 24 of shape that conforms to the shapes of the inner wall 17 and the bottom surface 16 of the recess 15, and an insertion portion 21 that is suspended from the main body 24 and inserted into the through hole 18 of the recess 15. In the main body 24, the radial direction passage 23 is formed linked to the straight passage 5. In the main body 24, an overhanging portion 24a is formed having a hole for inserting a screw or the like therethrough.

The circulation member 8 is fixed to the recess 15 of the nut main body 2 with fixing means such as a screw.

The planer shape of the main body 24 is the same as that of the bottom surface 16 of the recess 15. As illustrated in FIG. 6, in the cross section perpendicular to the axial line of the nut main body 2, the outer wall 24b of the main body 24 is parallel with the inner wall 17 of the recess 15 of the nut main body 2 and also in parallel with the line connecting the center P1 of the nut main body 2 and the center P2 of the straight passage 5. The outer wall 24b of the main body 24 of the circulation member 8 is in contact with the inner wall 17 of the recess 15 of the nut main body 2 and the insertion portion 21 of the circulation member 8 is fit in the through hole 18 of the recess (see FIG. 5), and thereby, the position of the circulation member 8 in the XY directions is determined in the plan view of the nut main body 2. In addition, as the bottom surface 24c of the main body 24 of the circulation member 8 is in contact with the bottom surface 16 of the recess 15, the position of the circulation member 8 in the Z direction is determined. As the circulation member 8 can be positioned accurately with respect to the loaded ball rolling groove 2a of the nut main body 2, the balls 7 can be moved smoothly between the unloaded return passage 9 and the loaded ball rolling passage 3.

In the insertion part 21 of the circulation member 8, the curve passage 22 is formed connected to the loaded ball rolling passage 3. At a lower end of this insertion part 21, a scooping part 21a is formed in the ball rolling groove 1a of the screw shaft 1 for scooping each ball rolling on the ball rolling groove 1a of the screw device 1 into the curve passage 22. As the scooping part 21a scoops the ball 7 along the circular arc that is in contact with the loaded ball rolling passage 3, if the ball 7 comes into contact with the scooping part 21a, an impact given to the scooping part 21a is small.

This circulation member 8 is a molded component of resin such as POM, and may be formed of a pair of split parts along the unloaded return passage 9 or one undivided component. As the scooping part 21a is made of resin, the scooping part 21a is easy to deform and the impact given from the ball 7 to the scooping part 21a can be attenuated. Here, the paired circulation members 8 are formed by the same die into the same shape.

Here, the above-described exemplary embodiment is not intended for limiting the present invention and various modifications may be made without departing from the scope of the present invention. For example, only one ball circulation passage may be provided in the nut main body. If two or more ball circulation passages are provided, two or more loaded ball rolling grooves may be in phase so as not to preload the ball screw.

The center line of the curve passage of the unloaded return passage may not be arc shaped but a clothoid curve having continuous tangential directions. The arc-shaped curve includes, as well as an arc curve, an ellipse curve, a clothoid curve and the like.

A pipe may be inserted into the inside of the straight passage or a tubular resin may be molded by insertion to be integral with a hole.

The rolling elements may be rollers instead of balls. And, a retainer may be provided between rolling elements to prevent contact therebetween.

The circulation members may be of the same shape or different shapes.

The present invention is not limited to the above described embodiments, and various variations and modifications may be possible without departing from the scope of the present invention.

This application is based on the Japanese Patent application No. 2009-085249 filed on Mar. 31, 2009, entire content of which is expressly incorporated by reference herein.

What is claimed is:

1. A rolling-element screw device comprising:
a screw shaft having a spiral rolling-element rolling groove formed on an outer peripheral surface thereof;
a nut main body having a spiral loaded rolling-element rolling groove formed on an inner peripheral surface thereof, facing the rolling-element rolling groove of the screw shaft;
a plurality of rolling elements arranged in a rolling-element circulation passage including a loaded rolling-element rolling passage between the loaded rolling-element rolling groove of the nut main body and the rolling-element rolling groove of the screw shaft;
a straight passage provided in the nut main body and having a hole extending in parallel with an axial line of the nut main body; and
a pair of circulation members provided at respective ends of the straight passage of the nut main body and each having formed therein a direction change passage for connecting the loaded rolling-element rolling passage and the straight passage, the circulation members being formed in an outer diameter portion of the nut main body and fit in a pair of recesses, respectively, connected to the straight passage, the direction change passage of each of the circulation members having a curve passage connected to the loaded rolling-element rolling passage, and the curve passage being formed in such a manner that a track of a center of each of the rolling elements moving in the curve passage takes an arc shape when seen in an axial direction of the nut main body.

2. The rolling-element screw device according to claim 1, wherein the rolling-element circulation passages comprises two or more rolling-element circulation passages which are provided at positions shifted from each other in the axial direction of the nut main body, the straight passage provided in the nut main body comprises two or more straight passages having respective center lines in agreement with each other, and the pair of circulation members is provided at respective ends of each of the straight passages of the nut main body.

3. The rolling-element screw device according to claim 2, wherein the two or more rolling-element circulation passages include two or more loaded rolling-element rolling grooves of the nut main body, and a phase of one of the two or more loaded rolling-element rolling grooves relative to the rolling-element rolling groove of the screw shaft is shifted from a phase of an other of the loaded rolling-element rolling grooves so that the rolling-element screw device is preloaded.

4. The rolling-element screw device according to any one of claims 1 to 3, wherein the rolling-element rolling groove of the screw shaft comprises two or more rolling-element rolling grooves, the loaded rolling-element rolling groove of the nut main body comprises two or more loaded rolling-element rolling grooves, the rolling-element circulation passage comprises two or more rolling-element circulation passages corresponding in number to the rolling-element rolling grooves of the screw shaft and the loaded rolling-element rolling grooves of the nut main body, the two or more rolling-element circulation passages are provided at positions overlapping each other in the axial direction of the nut main body, the straight passages comprises two or more straight passages corresponding in number to the rolling-element rolling grooves of the screw shaft and the loaded rolling-element rolling grooves of the nut main body, the two or more straight passages are provided at positions shifted from each other in a circumferential direction of the nut main body, and the pair of circulation members is provided at respective ends of each of the straight passages of the nut main body.

5. The rolling-element screw device according to any one of claims 1 to 3, wherein the nut main body has formed therein a through hole passing from an end surface of the nut main body to an opposite end surface thereof and a part of the through hole comprises the straight passage.

6. The rolling-element screw device according to claim 2 or 3, wherein the circulation members are arranged almost in a line in the axial direction of the nut main body.
